(19) United States
(12) Patent Application Publication
(10) Pub. No.: US 2018/0257906 A1
(43) Pub. Date: Sep. 13, 2018

(54) CONTROL METHOD FOR AN ELEVATOR CONTROL SYSTEM

(71) Applicant: KONE Corporation, Helsinki (FI)

(72) Inventors: Marja-Liisa SIIKONEN, Helsinki (FI); Janne SORSA, Helsinki (FI); Juha-Matti KUUSINEN, Helsinki (FI)

(73) Assignee: KONE Corporation, Helsinki (FI)

(21) Appl. No.: 15/975,416

(22) Filed: May 9, 2018

Related U.S. Application Data
(63) Continuation of application No. PCT/EP2015/077421, filed on Nov. 24, 2015.

(51) Int. Cl. B66B 1/24

(52) U.S. Cl. CPC B66B 1/2458; B66B 2201/403; B66B 2201/302; B66B 2201/104

(57) ABSTRACT

An elevator control method for an elevator system including cars movable in an elevator shaft of a building the building being dividable into serving sectors each serving sector including at least one floor to be served by a car, and a recording device for recording car usage data, the recording device being dedicated to the cars, wherein the recording device forwards the car usage data to an elevator controller receiving the car usage data for creating car-logbook-data. The method of division of the serving sectors is decided on evaluation-analysis of the car-logbook-data by gathering and storing the car usage data over a period of time into a memory of the elevator controller and allocating a serving sector in dependency of the evaluation-analysis of the car usage data respectively.

### FIELD OF THE INVENTION

The present invention relates to an elevator control method for an elevator system having multiple elevators installed as a group.

### BACKGROUND OF THE INVENTION

In modern buildings so called group-controlled elevators are equipped with multiple car controllers into which data from each elevator car are laid down for i.a. controlling the operation of the cars, respectively.

From U.S. Pat. No. 5,831,226 such an elevator-system with multiple cars is known for a building being equipped with destination floor boarding location buttons provided on the lobby floor. This aims to enter the destination floor by the passengers not within a car but already before going inside. Hence it is possible to collect several calls and to serve them by having previously allocated different floors to service-sectors of the building which are predefined in the memory of the controller. To this end, the controller switches between two operation modes, namely a normal operation serving a single call, and a peak-demand-mode encountering the service for sectors and putting a higher level controller into service. In the normal mode, when a call occurs on a certain floor, a controller calculates the time in which each car can respond to the aforementioned call and then assigns the car that can respond most rapidly to the aforementioned call. When however it is determined that the higher level controller is in service, all the floors are divided up to the predefined sectors in response to the aforementioned destination floor boarding calls, and sequencing of service in each sector will be in the order in which each destination floor boarding call has occurred. If however the building occupation changes (a company will get more floors in a building), the control features do not work any longer without changes in the software of the controller.

### AIM OF THE INVENTION

The object of the invention is to provide an elevator control method that is improved in view of dividing the multi-floor building into service-sections, respectively, and to handle a car allocation correspondingly.

### SUMMARY OF THE INVENTION

The above object is achieved by the method according to claim 1. Advantageous embodiments are disclosed in the respective dependent claims.

Users of elevators of multipurpose buildings may be people who have once to get something done in the building like visiting a person or coming for a single customer meeting. There are further those persons who are in use for a specific period of time, for example when being guest in a hotel which is accommodated in the building. At least there can be tenants who are in the building using frequently specific floors over a long time. If there is a lot of inter-floor traffic between upper floors—not from or to the entrance floor, then there can be defined a tenant defining therewith a servicing zone for the elevator. Such inter-floor traffic can be recognized by using traffic event data like elevator starts, car position and their direction, etc., by also encountering accurate load of a car and photocell signals. This definition of service-zones is thus made as a result of evaluating journey-data of the elevator car or cars. For example, a tenant can be also a firm with a number of employees which firm rents multiple floors in the building. The firm's employees therefore create a specific traffic in-between the floors belonging to the firm, meaning that a higher frequented movement can be recognized on these floors compared to the overall usage of all the cars belonging to the elevator system of the building. Therewith, a specific service-sector for the firm is to be defined, meaning that a specific elevator-car or cars are allocated to serve the traffic of such busy tenant in a more intelligent way. This means to split the elevator group into those elevator(s) which preferentially serve the traffic of said tenant when being excessively busy, while another car or cars are not, but for free order for the remaining passengers. This leads to that the service of other tenants is no longer disturbed.

With the present invention, the elevator control learns the changing occupation in a multitenant building to define service sectors continuously by gathering the journey data and storing the same as a logbook in the controller. In an office building for example, serving one tenant at a time with no passenger from other zones, namely other tenants, or other floors a service zone can be applied automatically without any manual input. The tenant or tenants can be served with one or more cars so that these do not serve other tenants at the same time. After becoming vacant said car then can serve any other tenant.

This also is useful in a building where e.g. an elevator group serves hotel floors and parallel office floors occupying specific floors. Then elevators can automatically be dedicated to serve one tenant at a time. According to the invention, the elevator system continuously identifies floor limits for each tenant, i.e. service zone, by monitoring the interfloor traffic. Typically, this means to evaluate statistical floor-to-floor transport data over time periods, e.g. of weeks, of months, etc.

To this end, the invented elevator system comprises cars movable in an elevator shaft of a building the building being dividable into serving sectors, wherein each serving sector comprising several floors—at least two of them—to be served by an elevator car. There are further car recording means for recording individual car usage data which are forwarded to an elevator controller receiving the car usage data for creating car-logbook-data. A division of the serving sectors is then decided on basis of an evaluation-analysis of the car-logbook-data by gathering and storing the car usage data over a period of time into a memory of the elevator controller and allocating a serving or service sector, to continuously identify floor limits for each serving zone. Therewith the even the number of service zones can change from time to time as a result of the continuously evaluation of the traffic data.

In other words, the invention implements to learn from a changing occupation of each elevator car in a multi-service-sector building and adapts the service for the users of the elevators, e.g. the tenants of the building. According to the invention passenger journeys from the origin to the destination floor are recognized, stored in a memory and evaluated for defining limits of service-zones. These journey-data can comprise elevator events like time, floor number, direction, start load, DCS passenger call, or landing and car calls and can also comprise passenger events like time, origin floor, and destination floor being measured continuously by the control-system. From the detected events passenger journeys from origin to destination floors can thus be deduced. From the inter-floor traffic component between the floors the floor range where the journeys mostly occur can be found out.

The invention provides the advantage that the elevator system is intelligent and uses the car usage data to adapt the zone-allocation to a changing occupation. For this adaption no software update is needed because the system adapts automatically and learns about a changed occupation in the building within a short period which can be determined individually, for example over weeks, while the result is then automatically updated by encountering the actualized traffic data. There is thus no manual input needed for defining the service-zones.

As a consequence the elevator system is capable of adapting to the usage of tenants of a building very precisely. Especially when the evaluation-analysis of the car-logbook-data combines parameters recorded by the recording means and allocates the serving sector in dependency of a probability of occurrence of a serving call, the elevator system for example learns how many tenants use the elevator system starting from which origin floor at what time. As a consequence the elevator system is able to allocate a car to the corresponding serving sector at the recorded time. To reduce a waiting time for a tenant of a building the elevator controller allocates the car for serving tenants at a minimum of time.

To further improve a performance of the elevator system and to realize learning from a changing occupation as quick as possible evaluation-analysis of the car-logbook-data and allocating a serving sector in dependency of the car usage data is performed continuously.

As in practice, when a new destination call is registered, the system checks if there is already an older call registered and allocated to a floor belonging to the same tenant-sector. If so, the new call is allocated to the same car that is allocated to the older call, this means that people belonging to the same tenant, i.e. service sector are served with a same car or same cars. Association between cars and tenant sectors can be fixed, on dynamic and/or based on time/traffic demand. If dynamic association is used, any vacant (non fixed) car can be associated with any tenant-sector.

According to another embodiment each car comprises a dedicated recording means. This embodiment provides the advantage that the plurality of cars can be allocated to different origin floors where a serving call is expected at a certain time. As a consequence the performance of the elevator system can be further improved and a waiting time for a tenant of a building can be further reduced.

To further increase the performance of serving tenants of a building and to ensure it even in tall multipurpose buildings with a high number of tenants the elevator system comprises a least two groups of cars wherein each group comprises a plurality of cars.

Embodiments of the invention are shown in the figures and they are explained in the following description.

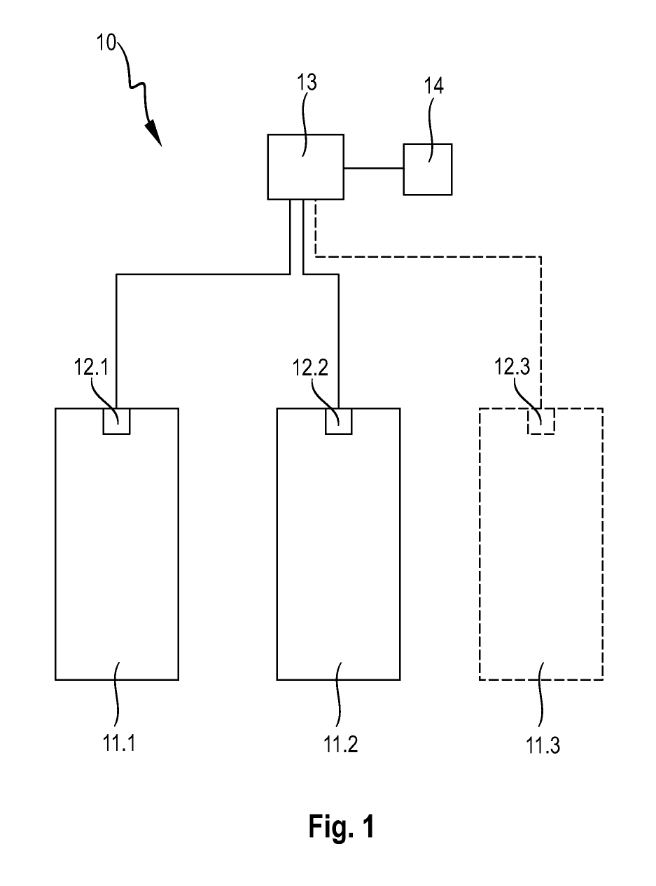

FIG. 1 shows a schematic view of an elevator system,

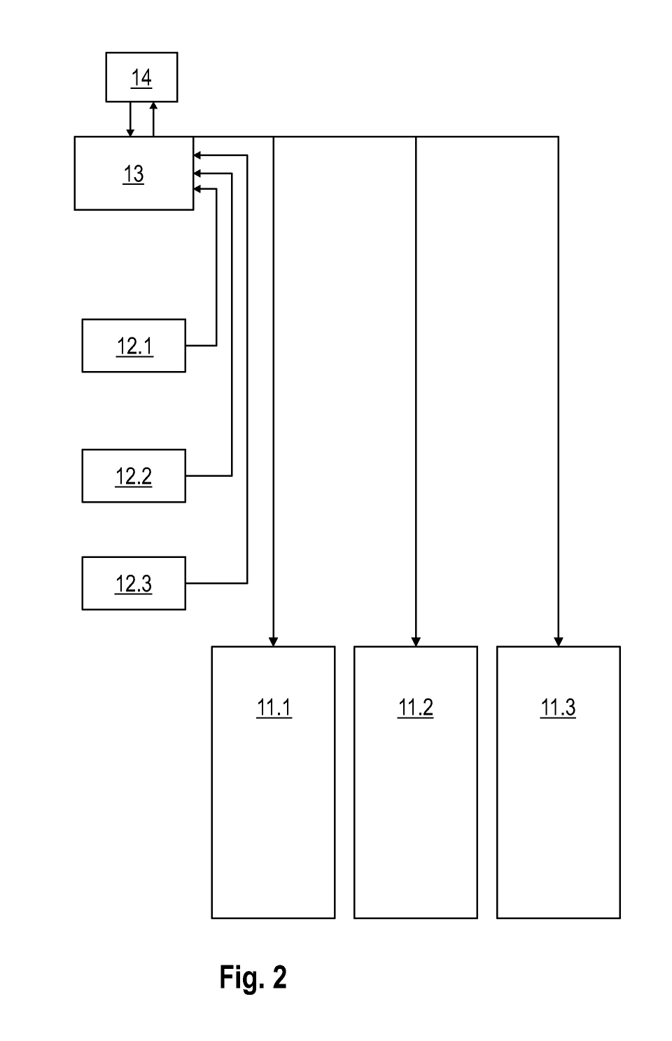

FIG. 2 shows a schematic view showing channels of communication of an elevator system,

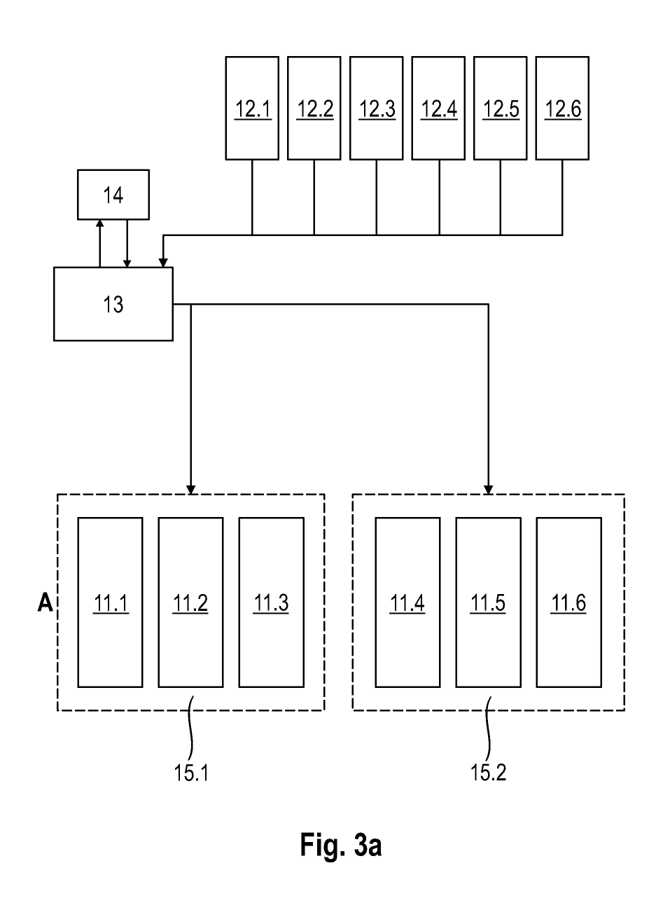

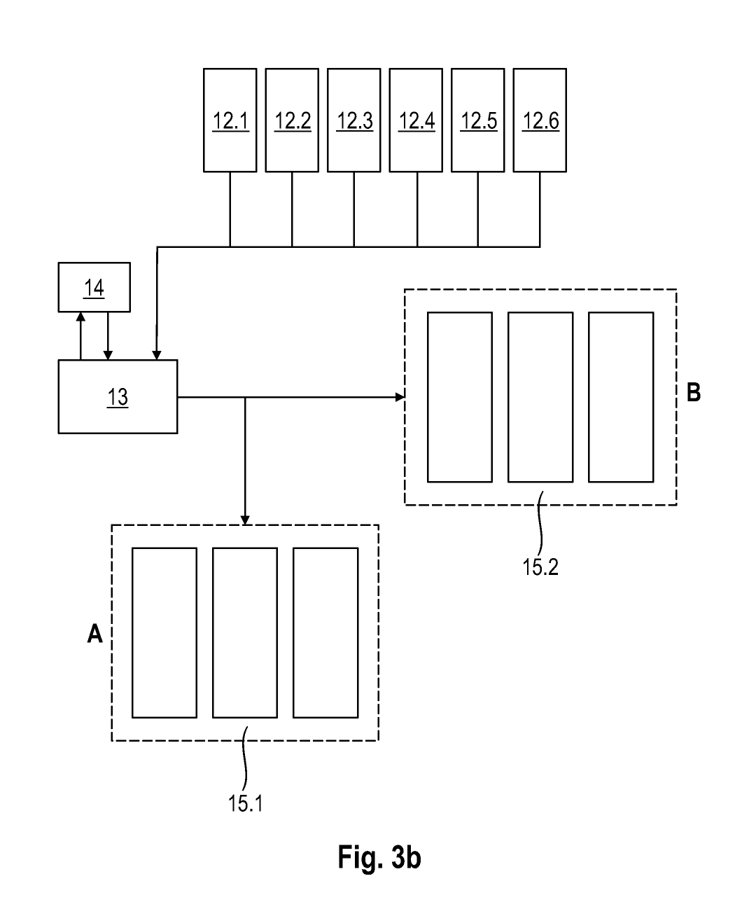

FIG. 3a shows a schematic view showing channels of communication of an elevator system comprising two groups of cars, and

FIG. 3b shows another schematic view showing channels of communication of an elevator system comprising two groups of cars.

FIG. 1 shows a schematic view of an elevator system 10. The elevator system 10 comprises three cars 11.1, 11.2, 11.3 movable in an elevator shaft of a building. Each car 11.1, 11.2, 11.3 comprises a recording means 12.1, 12.2, 12.3 for recording car usage data like elevator events as car position data and car call data, time, floor number, direction, start load, DCS passenger call, or landing and car calls and can also comprise passenger events like time, origin floor, and destination floor. The recording means 12.1, 12.2, 12.3 forwards the car usage data to an elevator controller 13 receiving the car usage data for creating car-logbook-data. Further the elevator controller 13 comprises a memory 14 for gathering and storing the car usage data over a period of time. The controller 13 calculates and processes the constantly changing positions and direction of movement of the cars, the circumstances of car calls and boarding calls, car load conditions, car departure interval conditions, and other types of traffic data to control movement of the cars in response to traffic demands, and assigns the most appropriate cars to floors where passengers are waiting.

From congested floors, such as the lobby floor, the cars will often be completely filled so that a large number of passengers may board. For this case, destination boarding location buttons which are the same as the destination floor buttons on the car operating panel, are provided at these boarding locations. When the destination floor boarding location buttons at these boarding locations are pressed, it will not be necessary to press the destination floor buttons on the car operating panels inside the cars. On the lobby floor, destination floor boarding location buttons are provided in front of elevators 11.1, 11.2 and 11.3.

After a call has been entered, the controller 13 determines whether the destination floor belongs to a service-sector. Then, the controller determines whether there is another destination floor boarding call for this same sector. When there is no further call for said first sector, the priority level of this sector is tentatively made 1. Next, it is determined if another, second service-sector with a priority level that precedes the first sector, has a destination floor boarding call that belongs to this sector. When the second sector already has had a destination floor boarding call, the priority level of the second sector becomes 1, and the priority level of the first sector is determined to be 2. On the other hand, when the second sector has no call, the priority level of the first sector is determined to be kept at 1. In this way, the priority levels of both sectors are made 1 and 2, etc. depending on the number of service sectors and the sector service order becomes the order in which destination floor boarding calls occur. In addition, when a car departs from the lobby floor to a destination floor that belongs to the first sector, the priority level of the second sector becomes 1.

FIG. 2 shows a schematic view showing channels of communication of an elevator system 10. The recording means 12.1, 12.2, 12.3 records car usage data, for example an origin floor where a serving call occurs, a destination floor, a time when a serving call occurs, a start load, an elevator position, or an elevator moving direction. The recording means 12.1, 12.2, 12.3 forwards the car usage data to the elevator controller 13. The elevator controller 13 gathers and stores the car usage data for creating car-logbook-data using a memory 14. The elevator controller 13 performs an evaluation-analysis of the car-logbook-data, divides serving sectors of the building based on evaluation-analysis of the car-logbook-data and allocates serving sectors (not shown) to the cars 11.1, 11.2, 11.3 by defining their limit-floors, respectively.

FIG. 3a shows a schematic view showing channels of communication of an elevator system 10 comprising two groups 15.1, 15.2 of cars 11.1, 11.2, 11.3, 11.4, 11.5, 11.6. The recording means 12.1, 12.2, 12.3, 12.4, 12.5, 12.6 records car usage data, for example an origin floor where a serving call occurs, a destination floor, a time when a serving call occurs, a start load, an elevator position, or an elevator moving direction. The recording means 12.1, 12.2, 12.3, 12.4, 12.5, 12.6 forwards the car usage data to the elevator controller 13. The elevator controller 13 gathers and stores the car usage data for creating car-logbook-data using a memory 14. The elevator controller 13 performs an evaluation-analysis of the car-logbook-data, divides serving sectors of the building based on evaluation-analysis of the car-logbook-data and allocates serving sectors (not shown) to the cars 11.1, 11.2, 11.3, 11.4, 11.5, 11.6, by defining their limit-floors, respectively. Regarding the recording means 12.1, 12.2, 12.3, 12.4, 12.5, 12.6, the elevator controller 13 and the memory 14 there is no difference compared to the embodiment shown in FIG. 2. The two groups of cars 15.1, 15.2 further increase the performance of serving tenants of a building because in dependency of the usage of tenants in a building different groups of cars can be allocated to different serving sectors in a building. Group 15.1 and group 15.2 are both allocated to a serving sector A.

FIG. 3b shows another schematic view showing channels of communication of an elevator system 10 comprising two groups of cars 15.1, 15.2. FIG. 3b shows identical features shown in FIG. 3a. The only difference is in the allocation of group 15.1 and group 15.2. Group of cars 15.1 is allocated to the serving sector A and the group of cars 15.2 is allocated to serving sector B.

All features shown or discussed with respect to particular embodiments of the invention can be combined in various applicable combinations in order to realize their positive technical effects simultaneously.

The scope of the present invention is given by the claims and is not restricted by the exemplary embodiments discussed in the description or depicted in the figures.

### REFERENCE NUMERALS

10 elevator system
11 car
12 recording means
13 elevator controller
14 memory
15 group of cars
A, B serving sector

1. An elevator control method for an elevator system comprising:
elevator cars movable in an elevator shaft of a building the building being dividable into serving sectors each serving sector comprising several floors to be, served; and
recording means for recording car usage data the recording means being dedicated to the cars, wherein the recording means forward the car usage data to an elevator controller receiving the car usage data for creating car-logbook-data, and
wherein a division into serving sectors is decided by defining limit floors of each sector on evaluation-analysis of the car-logbook-data by continuously monitoring interfloor traffic and gathering and storing the car usage data over a period of time into a memory of the elevator controller and allocating a serving sector in dependency of the evaluation-analysis of the car usage data, respectively.

2. The elevator control method according to claim 1, wherein the recording means records car usage data comprising parameters of an elevator usage by tenants of a building.

3. The elevator control method according to claim 1, wherein the recording means records car usage data comprising at least one of the following parameters:
an origin floor where a serving call occurs,
a destination floor,
a time when a serving call occurs,
a start load,
an elevator position, or
an elevator moving direction.

4. The elevator control method according to claim 1, wherein the evaluation-analysis of the car-logbook-data combines parameters recorded by the recording means and allocates the serving sector to a car in dependency of a probability of occurrence of a serving call.

5. The elevator control method according to claim 1, wherein the elevator controller allocates the car for serving tenants at a minimum of time.

6. The elevator control method according to claim 1, wherein the elevator system comprises a least two groups of cars wherein each group comprises a plurality of cars.

7. The elevator control method according to claim 2, wherein the recording means records car usage data comprising at least one of the following parameters:
an origin floor where a serving call occurs,
a destination floor,
a time when a serving call occurs,
a start load,
an elevator position, or
an elevator moving direction.

8. The elevator control method according to claim 2, wherein the evaluation-analysis of the car-logbook-data combines parameters recorded by the recording means and allocates the serving sector to a car in dependency of a probability of occurrence of a serving call.

9. The elevator control method according to claim 3, wherein the evaluation-analysis of the car-logbook-data combines parameters recorded by the recording means and allocates the serving sector to a car in dependency of a probability of occurrence of a serving call.

10. The elevator control method according to claim 2, wherein the elevator controller allocates the car for serving tenants at a minimum of time.

11. The elevator control method according to claim 3, wherein the elevator controller allocates the car for serving tenants at a minimum of time.

12. The elevator control method according to claim 4, wherein the elevator controller allocates the car for serving tenants at a minimum of time.

13. The elevator control method according to claim 2, wherein the elevator system comprises a least two groups of cars wherein each group comprises a plurality of cars.

14. The elevator control method according to claim 3, wherein the elevator system comprises a least two groups of cars wherein each group comprises a plurality of cars.

15. The elevator control method according to claim 4, wherein the elevator system comprises a least two groups of cars wherein each group comprises a plurality of cars.

16. The elevator control method according to claim 5, wherein the elevator system comprises a least two groups of cars wherein each group comprises a plurality of cars.
